(19) United States
(12) Patent Application Publication
(10) Pub. No.: US 2009/0302033 A1
(43) Pub. Date: Dec. 10, 2009

(54) AUTOMATED HAND HELD SEALER

(75) Inventor: Lawrence D. Barr, Tucson, AZ (US)

Correspondence Address: The von HELLENS LAW FIRM, LTD.;C. Robert von Hellens, 7330 N 16TH STREET, SUITE C 201, PHOENIX, AZ, 85020, US

(73) Assignee: ENGINEERING & RESEARCH ASSOCIATES, INC., TUCSON, AZ (US)

(21) Appl. No.: 12/133,340

(22) Filed: Jun. 4, 2008

(51) Int. Cl. H05B 6/64; B65B 9/00

(52) U.S. Cl. 219/769; 53/451

(57) ABSTRACT

A body of an automated hand held tubing sealer encloses an electric motor, a drive train responsive to the electric motor, a source of RF energy, a switch for initiating operation of the electric motor and limit switches for controlling operation of the source of RF energy as a function of the drive train and a programmable microprocessor for controlling and varying any of numerous parameters. A sealing head assembly is formed by a fixed jaw and a movable jaw to compress tubing placed therebetween in response to operation of the drive train and to melt the compressed tubing as a function of operation of the source of RF energy. A fitting permits selectively detachably attaching the sealing head assembly with the body at any of more than one angularly displaced positions.

### BACKGROUND OF THE INVENTION

1. Field of the Invention

The present invention relates to a radio frequency energized hand sealer for tubing and, more particularly, to automated microprocessor controlled hand held sealers having reorientable interchangeable sealing heads.

2. Description of Related Prior Art

At blood collection centers, a needle is inserted into the vein of a donor to draw blood. The needle is connected through a length of tubing to a blood collection bag. On completion of the blood collection process, a phlebotomist or clinician uses a hand operated tubing sealer or a desk mounted tubing sealer to make a number of seals along the length of the tubing. These seals serve two purposes. First, they prevent outflow of blood from the collection bag. Secondly, and very importantly, a plurality of segments of blood-filled tubing are developed. These segments are separated for purposes of testing the blood contained therein to type the blood, detect the presence of disease and other purposes.

The hand operated tubing sealers used for decades include a lever that must be squeezed to close or nearly close the jaws of the hand sealer. Upon such closure, the tubing is compressed and radio frequency (RF) energy is transmitted across the jaws for the purpose of melting the tubing to form a weld thereacross. The repetitive squeezing of the handle associated with the hand sealer becomes fatiguing and possibly gives rise to various medical problems, such as carpal tunnel syndrome. As many persons at a blood collection center are volunteers, and as such volunteers are often aged, fatigue may set in rapidly creating discomfort and possible trauma. Existing hand sealers for tubing have a fixed orientation of the jaws. During certain procedures for sealing tubing, whether in a blood donor environment or in a commercial or manufacturing environment, the hand sealer may have to be rotated to a particular orientation to engage and squeeze the tubing. In view of the fixed orientation of the handle relative to the orientation of the sealing jaws, it may be difficult for an operator to perform effective seals.

To alleviate the manual strain of using hand-operated tubing sealers, desk mounted tubing sealers have been developed and used. Sealers of this type require only that an operator insert the tubing to be sealed between a pair of jaws. Upon insertion of the tubing between the pair of jaws, a micro switch or the like may be actuated to cause the pair of jaws to squeeze the tubing and apply RF energy. Alternatively, a foot operated switch may be used for this purpose. While desk mounted tubing sealers alleviate the strain imposed by hand operated tubing sealers, limitations of location are present.

The pair of jaws of a tubing sealer, whether hand operated or desk mounted, are configured to squeeze and apply RF energy to a predetermined size and wall thickness of plastic tubing. Additionally, existing tubing sealers are designed to produce seals across tubing of a particular composition/material. In the event different sized tubing or tubing of different composition is to be sealed, a hand operated or desk mounted sealer designed for such tubing size/tubing composition must be used. At a facility wherein different sized tubing or tubing of different compositions must be periodically sealed, a significant inventory of hand operated and/or desk mounted tubing sealers must be available. Such additional equipment necessarily incurs the expenses of an adequate inventory and storage related costs.

### SUMMARY OF THE INVENTION

The present invention is directed to an automated hand sealer for automatically squeezing the tubing to be sealed and applying radio frequency (RF) energy to melt the tubing and form a weld there across in response to the compression of the tubing effected by a fixed and a movable jaw. The hand sealer is activated by a simple push button switch to close an electric circuit and an electric motor, through a drive train, causes movement of the movable jaw toward the fixed jaw to squeeze tubing therebetween. The electric circuit includes a programmable microprocessor to control the operation of the electric motor and control and vary the generation of RF energy as a function of the movement of the drive train and control and vary transmission of the RF energy across the fixed and movable jaws to heat the tubing sufficiently to cause it to melt. The melted tubing is compressed by the fixed and movable jaws resulting in a weld formed across the tubing. Thereby, the tubing is sealed. After the seal is formed, the movable jaw is translated to permit withdrawal of the sealed tubing. The fixed and movable jaws are formed as an assembly detachably attached to the body of the hand sealer. Thereby, fixed and movable jaws of different configurations to accommodate tubing of different sizes and composition may be readily attached. Additionally, the mode of detachably attaching such assembly permits attachment at any of four angularly displaced orientations with respect to the hand sealer to accommodate different orientations of the tubing to be sealed without the operator having to manually reorient the hand sealer to permit engagement of the tubing by the fixed and movable jaws.

The circuitry for effecting movement of the movable jaw and for transmitting RF energy preferably includes a microprocessor or the like to permit programming of the microprocessor to accommodate tubing of various sizes and compositions. Additionally, the automated hand sealer may be portable by providing a battery as a source of electrical power or it may be electrically connected to a conventional source of alternating current (AC) power.

It is therefore a primary of the present invention to provide an automated hand held tubing sealer actuated by a push button switch.

Another object of the present invention is to provide a hand held tubing sealer with interchangeable sealing head assemblies.

Still another object of the present invention is to provide a hand held tubing sealer with a sealing head assembly that may be angularly reoriented relative to the body of the hand sealer.

Yet another object of the present invention is to provide an automated hand sealer for tubing which requires minimal expertise and experience of an operator.

A further object of the present invention is to provide a hand operated tubing sealer that can accommodate any of differently configured sealing head assemblies to functionally match different size/different composition tubing.

A yet further object of the present invention is to provide an on board circuit, including a microprocessor, for selectively controlling and varying the movement of a movable jaw relative to a fixed jaw and the transmission of RF energy as a function of the position of the movable jaw.

A yet still further object of the present invention is to provide a method for automatically operating a hand held tubing sealer.

A yet further object of the present invention is to provide a method for interchanging the sealing head assembly of a hand operated tubing sealer.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 is a side elevational view of an automated hand held tubing sealer;

FIG. 2 is a top view of the automated hand held tubing sealer;

FIGS. 3A, 3B, 3C and 3D are end views of the sealing head assembly and illustrate four different orientations with respect to the body of the hand held tubing sealer;

FIGS. 4 is a partial cut away side view of the automated hand held tubing sealer;

FIG. 5 is a partial cut away top view of the automated hand held tubing sealer;

FIG. 6 is a partial cut away side view of the automated hand held tubing sealer and illustrates certain internal structure;

FIG. 7 is a partial cut away top view of the automated hand held tubing sealer and illustrates certain internal structure;

FIG. 8 is a side view of the detachably attachable sealing head assembly; and

FIG. 9 is an end view of the detachably attachable sealing head assembly.

### DESCRIPTION OF THE PREFERRED EMBODIMENT

FIGS. 1 and 2 illustrate a side elevational view and a top view of an automated hand held tubing sealer. Body 12 is generally cylindrical and supports an electrical connector 14 at rear end 18 of the body. A pressure sensitive switch 16, shown as an assembly, is mounted at the top of body 12 for actuation by an operator's thumb or finger. Upon actuation of the switch, the operation of the hand held sealer is set in motion and further switch actuation is unnecessary. A sealing head assembly 20 is detachably attached to front end 22 of body 12. The sealing head assembly includes a fixed jaw 24 in the form of a cylinder supported by a pair of displaced legs 26, 28. A movably jaw 30 includes a centrally mounted electrode 32 bracketed by non-electrically conducting material 34, 36, such as ceramic material or as plastic material sold under the trademark Delrin. An annular flange 38 supports legs 26, 28, accommodates rectilinear translation of movable jaw 30 and bears against front end 22 of body 12 to provide a solid supported contact therewith.

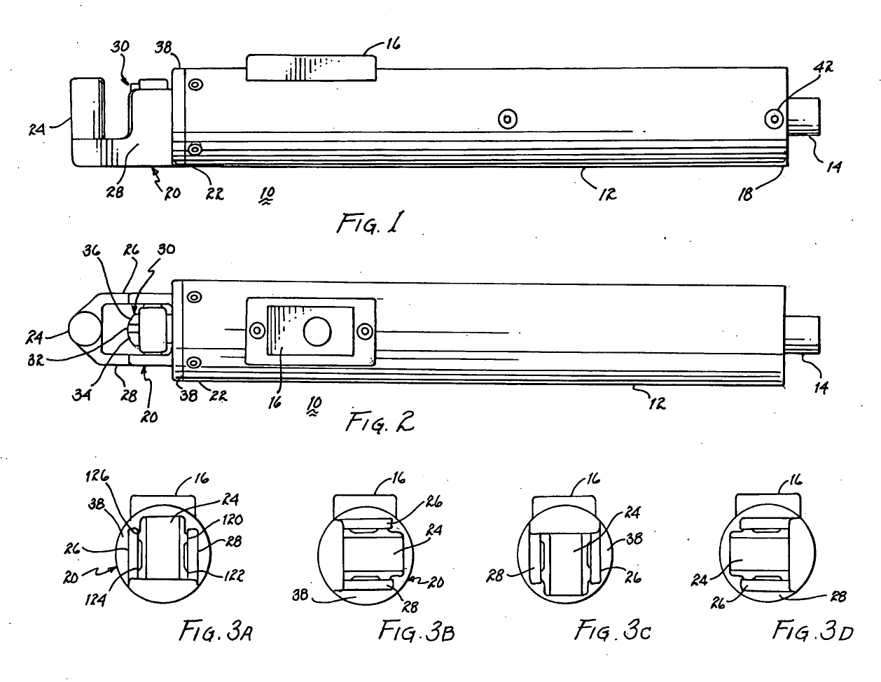

Sealing head assembly 20 is detachably attachable to body 12 by use of a pair of bayonet-type fitting (as will be described in more detail below). As particularly illustrated in FIGS. 3A, 3B, 3C and 3D, the sealing head assembly may be attached to the body in any of four angular orientations with respect thereto. FIG. 3A illustrates the sealing head mounted in the position shown in FIGS. 1 and 2. FIG. 3B illustrates the sealing head assembly rotated approximately 90° with respect to body 12. FIG. 3C illustrates the sealing head assembly rotated approximately 180° with respect to the body and FIG. 3D illustrates a sealing head assembly rotated approximately 270° with respect to the body. By attaching sealing head assembly 20 in any of these four orientations, an operator can use hand held sealer 10 in the normal position of switch 16 being uppermost and irrespective of the orientation of the tubing to be sealed. This capability is of a significant boon to an operator from the stand point of manipulating the hand held sealer to effect seals across tubing. Furthermore, it essentially eliminates angularly reorienting the hand held sealer about its longitudinal axis in order to ensure that the jaws are perpendicular to the tubing to be sealed when such tubing is other than horizontally oriented.

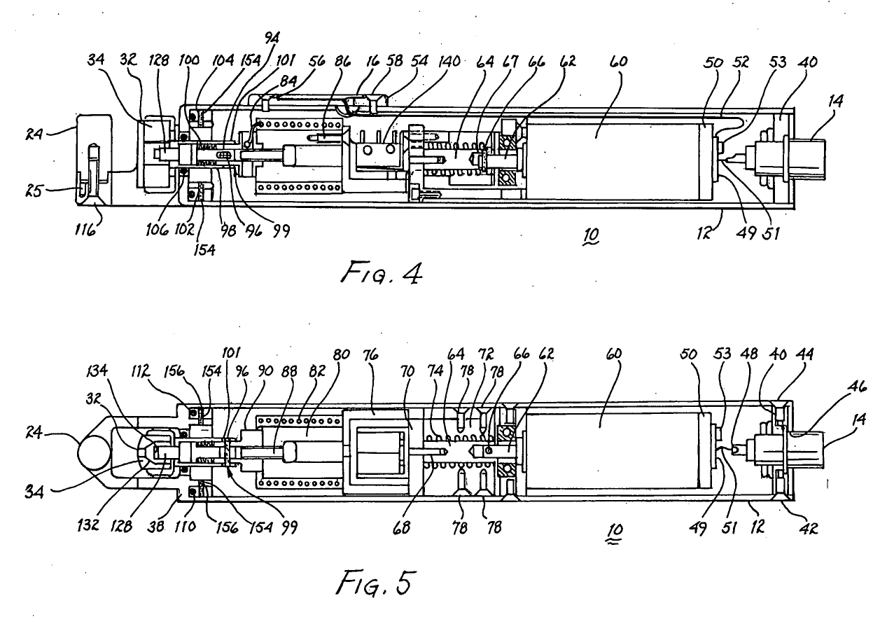

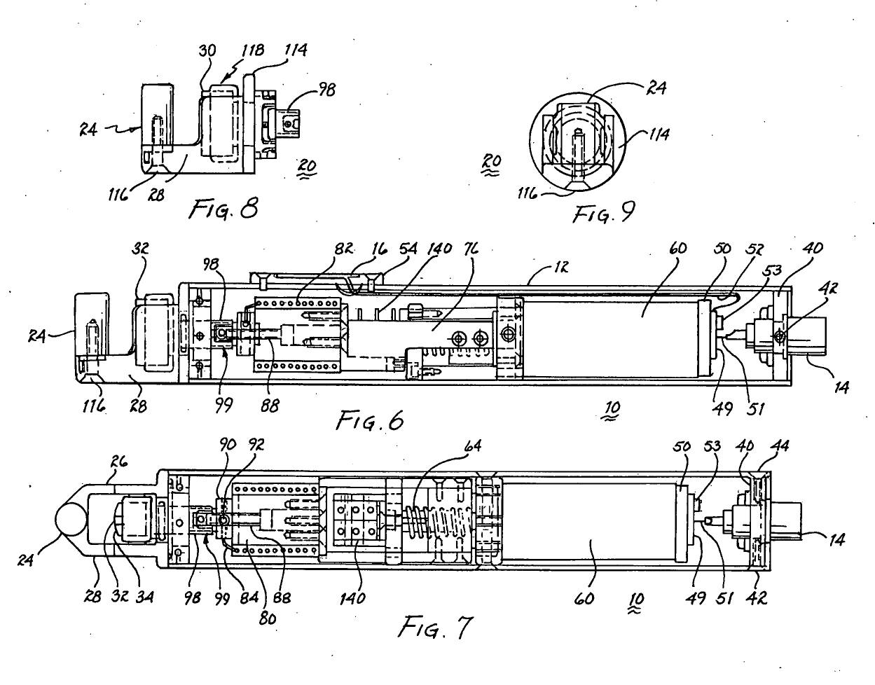

Referring jointly to FIGS. 4, 5, 6 and 7, there are shown various cutaway views of hand held sealer 10. FIGS. 4 and 6 illustrate side views of the hand held sealer with essentially the cover removed and certain internal structure, respectively. Similarly, FIGS. 5 and 7 show top views with essentially the cover removed and certain internal structure, respectively. Connector 14 may be a conventional female coaxial connector mounted within disc 40 attached to body 12 by screws 42, 44 and extending through an aperture 46 at the disc. A conventional electrode 48 extends from connector 14 for electrical attachment to circuit 49 mounted on circuit board 50 via conductor 51. Preferably, a programmable microprocessor 53 is mounted on the circuit board to control operation of circuit 49. Switch 16, which may be of any type of switch but is preferably a simple “on” switch for transmitting a signal to the circuit on circuit board 50 via an electrical conductor 52. As shown, casing 54 for switch 16 is attached to body 12 by screws 56, 58.

An electric motor 60 is mounted within body 12 and includes a geared rotatable output shaft 62. The shaft is coupled at one end of a screw 64 with a pin 66. The other end of the screw is supported on a pin 68 extending from a bulkhead 70. A nut 72 includes threads in mesh with threads 74 of screw 64. As screw 64 turns, the nut will move toward or away from bulkhead 70 as a function of the direction of rotation of shaft 62 of the motor.

A U shaped yoke 76 is secured to nut 72 by a plurality of screw 78. The other end of the yoke is attached to a block 80 of insulating material, such as the plastic sold under the trademark Delrin. An electrical coil 82 is disposed about block 80. One end of the coil is electrically connected to circuit 49 on circuit board 50 and the other end is connected through conductor 84 secured by screw 92 to movable jaw 30. Screws 86 secure block 80 with yoke 76. A shaft or screw 88 captured within block 80 extends therefrom into a guide post assembly 90 and is secured thereto. The guide post assembly includes a sleeve 94 supporting a pin 96 of a bayonet-type fitting 99. Sleeve 98 is coupled with movable jaw 30 and serves as a part of the bayonet-type fitting and configured to receive and mate with sleeve 94 for a reasonably tight fit. As is conventional with bayonet-type fittings, sleeve 98 includes slots 101 for receiving pin 96 in locking engagement. For reasons described below, sleeve 98 includes two orthogonally oriented sets of slots wherein either set of slots can lockingly engage with pin 96.

Preferably, there is a small amount of clearance between pins 96 and slots 101 in sleeve 98 during the initial attachment of sealing head assembly 20 with body 12. Such clearance renders it easier to guide the engagement of the slots with the pins. The primary purpose of bayonet-type fitting 99 is that of assuring movable jaw 30 is withdrawn from its closed position against (or close to) fixed jaw 24 when motor 60 is reversed to pull guide post assembly 90 (and pins 96) rearwardly. When the guide post assembly is pushed forwardly by operation of motor 60 and the drive train, it moves within sleeve 98 to push against and cause screw 128 to move towards fixed jaw 24 and force movable jaw 30 toward the fixed jaw. This movement also causes compression of spring 100; the slots in sleeve 98 are elongated in the longitudinal axis to allow compression of the spring to occur. The compressed spring serves to provide a continuing force on the movable jaw to urge compression of tubing placed between the fixed and movable jaws after motor 60 is turned off to enhance the electrical connection (transmission of RF energy) between guide post assembly 90 and screw 128.

A bushing 102 is mounted within frame 104 and extends inwardly from the interior of body 12 to slidably support sleeve 98. An 0 ring 106 is disposed between the bushing and the sleeve to prevent migration of fluid therebetween.

Sealing head assembly 20 will be described primarily with reference to FIGS. 8 and 9. Sleeve 98 constitutes, in essence, the female part of bayonet-type fitting 99. This female part, in combination with the pin of the male part of the bayonet-type fitting, permits detachment of the sealing head assembly by twisting the sealing head assembly a few degrees and pulling it away from body 12. Reassembly or replacement of the sealing head assembly is the reverse of this procedure. To ensure a seal between the sealing head assembly and body 12, an O ring 110 is lodged within annular support 112 attached to the interior of body 12. Upon assembly of the sealing head assembly, annular flange 38 bears against O ring 110 to compress it and effect a seal.

To further assure a fixed relationship between body 12 and sealing head assembly 20, a second bayonet-type fitting 150 may be incorporated. As particularly shown in FIGS. 4 and 5, a sleeve 152 extends from annular flange 38. A plurality of pins 154 extend internally from body 12 for engagement with slots 156 in sleeve 152, which slots are “L” shaped in the conventional manner of bayonet-type fittings. The orientation of pins 154 and slots 156 of bayonet-type fitting 158 correspond with pins 96 and slots 101 of bayonet-type fitting 99, whereby the two bayonet-type fittings simultaneously engage and disengage the sealing head assembly with the body. O-ring 110 serves also as a spring load to help keep the sealing head assembly tightly fixed in place against the body.

Fixed jaw 24 is secured to the apex of legs 26, 28 by a screw 116. Movable jaw 30 includes a jaw box 118 of dielectric material, such as the plastic sold under the trademark Dehin or an equivalent material. As particularly shown in FIGS. 3A, 3B, 3C and 3D, lands 120, 122, 124 and 126 are formed as part of the jaw box for bearing engagement with the walls of legs 26, 28; if the jaw box is of low friction material, such as the plastic sold under the trademark Delrin, very little friction between the jaw box and the legs is present and yet the jaw box will guide and maintain electrode 32 in alignment with fixed jaw 24.

The design of ground jaw assembly 28 incorporates removable fixed jaw 24 secured by a screw 116. The fixed jaw shown is cylindrical, but can be replaced easily by a jaw of different shape such as a flat faced jaw or one with an imbedded blade for making seals that are easily torn apart. A hole 25 is provided at the apex of legs 26 and 28 for an aligning pin that will mate with hole 25 in fixed jaw 24 if alignment of the jaw is necessary. Since the illustrated fixed jaw is cylindrical, that pin is not needed, but the option of an alignment pin exists.

Electrical contact between electrode 32 and sleeve 98 is achieved by a screw 128 extending through apertured end 130 of the sleeve. Ceramic material 34 or material sold under the trademark Delrin supports electrode 32 and has embedded therein a conductor 132 supporting electrode 32. The conductor includes a threaded cavity 134 for threadedly receiving screw 128. Thereby, electrode 32 is in electrical contact with conductor 84 via bayonet-type fitting 99 interconnecting the sealing head assembly with the body of the hand held sealer. For purposes of convenience, the elements interconnecting electric motor 60 with sleeve 98 of the bayonet-type fitting may be referred to as a drive train. More particularly, the drive train includes a number of components that may be summarized as motor 60, including a gear head, and shaft 62 coupled by pin 66 to screw 64 driving nut 72 to which yoke 76 is attached and causes opening and closing of movable jaw 30.

Control of translation of threaded nut 72 may be effected by various limit switches as is well known by those skilled in the art. These limit switches are representatively indicated by micro switch 140 mounted on bulkhead 70. As yoke 76 translates within body 12, various stops moving with yoke 76 may be implemented. As the microswitch translates within body 12, various stops may be implemented to actuate the microswitch as a function of movement toward and away from the fixed and moveable jaws. The signals generated by the microswitch are conveyed to the circuit 49 (microprocessor 53) on circuit board 50 to regulate/control operation of both the electric motor and the generation/application of RF energy.

Considerable axial force may be required to squeeze the tubing between the jaws during the RF sealing sequence, especially if the tubing walls are thick. The bearings of motor 60 cannot withstand such axial forces so the screw portion of the drive train is confined between a thrust bearing (not identified) in the motor mounting bulkhead (not identified) and another bulkhead 70 mounted on three standoff columns (not identified). A centering pin 68 in the upper bulkhead 70 keeps the screw centered while allowing it to rotate freely. A small amount of axial clearance is provided between the end of the screw and bulkhead 70 to reduce frictional losses that might otherwise occur. A slot 67 in screw 64 allows a small amount of axial movement of the screw relative to driving pin 66 as the driving action changes from closing the movable jaw to opening the movable jaw. The major axial force occurs when the jaws are closed and is supported by the thrust bearing while the minor axial force occurs when the jaws are open and is carried by bulkhead 70. The motor 60 experiences no axial force during either the opening or the closing of the movable jaw.

In operation, a phlebotomist or operator selects and attaches a sealing head assembly 20 to body 12 which conforms with the size and material of the tubing to be sealed. During such attachment, the operator determines the orientation of the sealing head assembly relative to the body to permit the most facile engagement with the tubing as a function of the orientation of the tubing. Upon placement of the tubing intermediate the ground jaw and the moveable jaw (hot jaw), switch 16 is actuated and a signal is transmitted into circuit 49 on circuit board 50. The circuit generates a signal and provides power to electric motor 60 resulting in rotation of shaft 62. The rotation of the shaft will cause translation of threaded nut 72 with commensurate translation of yoke 76 and to the components attached thereto. In particular, guide post assembly 90 will be translated with commensurate translation of the bayonet-type fitting 99 within bushing 102 resulting in movement of moveable jaw 30 toward fixed jaw 34. The resulting compression of the tubing will cause the interior surfaces of opposed side walls to come in contact with one another. As a function of the degree of compression of the tubing, the circuit will produce a signal to cause generation of RF energy and transmission of the RF energy to electrode 32 of the movable jaw. The RF energy will be transmitted through the tubing placed intermediate the fixed and moveable jaws and cause heating of the tubing. The heating of the tubing will continue until the tubing reaches a temperature sufficient to cause melt of the plastic. Simultaneously, the fixed and moveable jaws cause the melted (melting) opposed side walls of tubing to be melded with one another. Upon subsequent cessation of transmission of RF energy, the tubing will cool and a weld there across is formed. Numerous variations of the basic process for producing a seal across tubing are believed to be possible by appropriate programming of the attendant microprocessor in the circuit. For example, for thick walled tubing or relatively stiff tubing, the jaws may initially partially compress the tubing until the attendant forces threaten to cause motor 60 to stall. Prior thereto, RF energy may be produced and transmitted across the tubing and result in a softening of the tubing to permit compression of the tubing to continue. Thereafter, further RF energy, possibly at a higher power setting, may be applied to the tubing to cause melting and a subsequent weld across the tubing. Furthermore, tubing of different materials which have certain unique properties, can be effectively and quickly welded by applying a combination of pressure and level of RF power to effect melting and a subsequent weld.

The combination of the circuit and microprocessor on circuit board 50 coupled with the mechanical apparatus provides a number of useful functions available from the hand held sealer. The use of an on board programmable microprocessor responsive to the microswitches to control the functions to be performed render possible the following benefits heretofore not available from hand held or desk mounted tubing sealers:

1) Turning the drive motor on more than once. This action is highly useful for thick-walled tubing that cannot be squeezed enough to make a thin seal until the RF heating causes melting (softening). The initial squeezing is done to flatten the tube as much as the motor can accomplish. The RF generator is then turned on which heats the plastic followed by a second activation of the motor to finish the squeezing action.

2) It is well known that optimal RF heating is accomplished by electronically “tuning” the system at a given jaw separation. Closing the jaws tends to change the tuning and, hence, the heating ability of the RF energy. The onboard control circuit can be used to offset that effect by changing the power of the RF energy applied to the jaws.

3) It is known through experimentation that maintaining jaw separation at a fixed value during an RF heating cycle longer than required to achieve a simple seal can cause the temperature of PVC tubing to rise well above its nominal melting temperature of about 100° C. This effect may be used in certain applications to ensure sterilization or improved moldability of the seal region. The ability to close the jaws to a fixed separation for a controlled period of time followed by a seal-making squeezing action can be done with the onboard circuit board and microswitches.

It is to be understood that the use of a programmable microprocessor in the circuit on circuit board 50 has the benefit of being able to control and vary numerous functions of the hand sealer to obtain different characteristics of the seal to be formed. Tubing of different diametric size and wall thickness can be accommodated. The type of plastic and its unique characteristics can be addressed to obtain the type and nature of seals sought. These and other variables can be achieved by controlling and varying the force applied by the movable jaw and the extent of travel of the movable jaw toward the fixed jaw.

The generation and timing of RF energy applied can be controlled and varied as a function of the position of the movable jaw and the force applied related to the current draw of the motor. The level of power of RF energy applied can be controlled and varied as a function of the material of the plastic and the size of the tubing. The nature of the seal between the segments can be controlled and varied to permit segment separation with little force or a significant force as a function of the combination of the configuration of the fixed and movable jaws, the final dimension of separation therebetween and the degree of melt selected for a given type and size of tubing material.

In summary, the combination of mechanical elements controlled by a programmable circuit provides unlimited capability for achieving any type of seal across any type and size of tubing.

1. An automated hand held tubing sealer, said hand held tubing sealer comprising in combination:
a) a body for enclosing a circuit on a circuit board and an electric motor;
b) a sealing head assembly including a fixed jaw and a movable jaw;
c) a fitting for detachably attaching said sealing head assembly to said body;
d) a drive train energized by said motor in response to signals from said circuit board for translating said movable jaw toward and away from said fixed jaw to compress tubing therebetween upon activation of a switch; and
e) an RF generator for transmitting RF energy between said movable jaw and said fixed jaw in response to signals from said circuit board to melt the tubing and form a seal across the tubing.

2. The hand held tubing sealer as set forth in claim 1, wherein said fitting comprises a bayonet-type fitting.

3. The hand held tubing sealer as set forth in claim 2, wherein said body includes a longitudinal axis and wherein said bayonet-type fitting accommodates attachment of said sealing head assembly at any of more than one angular orientation about the longitudinal axis of said body.

4. The hand held tubing sealer as set forth in claim 2, wherein said body includes a longitudinal axis and wherein said bayonet-type fitting accommodates attachment of said sealing head assembly of any of four positions angularly oriented about the longitudinal axis of said body.

5. The hand held tubing sealer as set forth in claim 1, including a manually operated switch mounted on said body for activating the circuit on said circuit board.

6. The hand held tubing sealer as set forth in claim 1, wherein said fitting is adapted for manipulation by an operator prior to or subsequent to formation of a seal across the tubing.

7. The hand held tubing sealer as set forth in claim 6, wherein said fitting is spring loaded.

8. The hand held tubing sealer as set forth in claim 1, including at least one seal disposed intermediate said sealing head assembly and said body to restrain flow of fluid from about said sealing head assembly into said body.

9. An automated hand held tubing sealer, said hand held tubing sealer comprising in combination:
a) a body;
b) a sealing head assembly detachably attached to said body, said sealing head assembly including a fixed jaw and a movable jaw for compressing tubing therebetween;
c) an electric motor disposed within said body;
d) a drive train disposed within said body in operative engagement with said electric motor to translate said movable jaw toward and away from said fixed jaw;
e) a source of RF energy for transmitting RF energy from said movable jaw to said fixed jaw to melt tubing placed therebetween;
f) a circuit for controlling operation of said electric motor and said source of RF energy; and
g) a switch for activating said circuit to effect a seal across tubing placed between said fixed and movable jaws.

10. The automated hand held tubing sealer as set forth in claim 9, including a bayonet-type fitting disposed intermediate said body and said sealing head assembly.

11. The automated hand held tubing sealer as set forth in claim 10, wherein said bayonet-type fitting is spring loaded.

12. The automated hand held tubing sealer as set forth in claim 9, including at least one seal disposed intermediate said body and said sealing head assembly for restraining flow of fluid into said body.

13. The automated hand held tubing sealer as set forth in claim 12, wherein said seals comprise a pair of O-rings.

14. An automated hand held tubing sealer, said hand held tubing sealer comprising in combination:
a) a sealing head assembly including a fixed jaw and a movable jaw;
b) a body containing an electric motor for operating a drive train to move said movable jaw toward and apart from said fixed jaw, a source of RF energy for transmitting RF energy across said fixed and movable jaws to melt tubing therebetween, said body including a longitudinal axis;
c) a fitting for detachably attaching said sealing head assembly to said body and to said drive train; and
d) a switch for initiating operation of said electric motor and said source of RF energy.

15. The automated hand held tubing sealer as set forth in claim 14, wherein said fitting accommodates attachment of said sealing head assembly at any of more than one angular orientation about the longitudinal axis of said body.

16. The automated hand held tubing sealer as set forth in claim 14, wherein said fitting includes an annular flange formed as part of said sealing head assembly to bear against said body upon attachment of said sealing head assembly.

17. The automated hand held tubing sealer as set forth in claim 16, including at least one seal disposed intermediate said flange and said body to restrain flow of fluid from about said sealing head assembly into said body.

18. The automated hand held tubing sealer as set forth in claim 14, wherein said fitting is a bayonet-type fitting.

19. The automated hand held tubing sealer as set forth in claim 18, wherein said bayonet-type fitting is adjusted to attach said sealing head assembly to said body at more than one angular orientation relative to said body.

20. The automated hand held tubing sealer as set forth in claim 18, wherein said bayonet-type fitting is adapted to attach said sealing head assembly to said body at any of four orientations relative to said body.

21. A method for automatically forming a seal across a length of tubing, said method comprising the steps of:
a) activating a switch;
b) energizing an electric motor in response to said step of activating to cause compression of the tubing placed between a fixed jaw and a movable jaw; and
c) activating a source of RF energy to transmit RF energy across the fixed and movable jaws to melt the tubing placed therebetween and compressed by the fixed and movable jaws.

22. The method as set forth in claim 21, wherein the electric motor, the source of RF energy and the switch are part of a body and the fixed and movable jaws are part of a sealing head assembly and including the step of detachably attaching the sealing head assembly with the body.

23. The method as set forth in claim 22, wherein said step of detachably attaching includes the steps of disengaging and engaging, respectively, the elements of a bayonet-type fitting.

24. The method as set forth in claim 23, including the step of spring loading the bayonet-type fitting upon exercise of said step of engaging.

25. The method as set forth in claim 22, including the step of sealing the junction between the body and the sealing head assembly.

26. The method as set forth in claim 21, wherein said step of activating is initiated during exercise of said step of energizing.

27. The method as set forth in claim 22, wherein the switch is mounted on the body and wherein said step of activating is carried out manually buy an operator.

28. An automated hand held tubing sealer, said hand held tubing sealer comprising in combination:
a) a body for enclosing a circuit on a circuit board and an electric motor;
b) a sealing head assembly including a fixed jaw and a movable jaw;
c) a fitting for detachably attaching said sealing head assembly to said body, said fitting including a bayonet-type fitting;
d) a drive train energized by said motor in response to signals from said circuit board for translating said movable jaw toward and away from said fixed jaw to compress tubing therebetween upon activation of a switch;
e) an RF generator for transmitting RF energy between said movable jaw and said fixed jaw in response to signals from said circuit board to melt the tubing and form a seal across the tubing; and
f) a further bayonet-type fitting for electrically interconnecting said movable jaw with said RF generator.

29. A hand held tubing sealer as set forth in claim 28, including a microprocessor for controlling the transmission of RF energy to said movable jaw.

30. A hand held tubing sealer as set forth in claim 29, including limit switches electrically connected to said circuit board for producing electrical signals to control movement of said movable jaw.

31. A hand held tubing sealer as set forth in claim 29, including limit switches electrically connected to said microprocessor for controlling the transmission of RF energy to said movable jaw.

32. A method for automatically forming a seal across a length of tubing as set forth in claim 21, including the steps of controlling said steps of energizing and activating a source of RF energy with a microprocessor.

33. A method for automatically forming a seal across a length of tubing as set forth in claim 21, including the step of generating signals from a circuit board to control operation of said steps of energizing and activating a source of RF energy in response to said step of activating a switch.

34. A method for automatically forming a seal across a length of tubing as set forth in claim 21, wherein said steps of activating a switch, energizing an electric motor and activating a source of RF energy are carried out within a hand held sealer.

35. A method for automatically forming a seal across a length of tubing as set forth in claim 34, including the step of controlling said steps of energizing and activating a source of RF energy with a microprocessor mounted within the hand held sealer.

36. A method for automatically forming a seal across a length of tubing as set forth in claim 34, including the step of generating signals from a circuit board mounted within the hand held sealer to control operation of said steps of energizing and activating a source of RF energy in response to said step of activating a switch.

37. A method for automatically forming a seal across a length of tubing as set forth in claim 34, wherein the hand held sealer includes a body and wherein the fixed and movable jaws are part for sealing head and including the step of detachably attaching the sealing head to the body of the hand held sealer.

38. A method for automatically forming a seal across a length of tubing as set forth in claim 37, including the step of connecting the movable jaw with the source of RF energy through a bayonet-type fitting.

39. A method for automatically forming a seal across a length of tubing as set forth in claim 37, wherein said step of detachably attaching is carried out by a bayonet-type fitting.

40. A method for automatically forming a seal across a length of tubing as set forth in claim 39, including the step of connecting the movable haw with the source of RF energy through a bayonet-type fitting.
